(19) United States
(12) Patent Application Publication
(10) Pub. No.: US 2025/0346412 A1
(43) Pub. Date: Nov. 13, 2025

(54) PRESSURE SIGNALING SYSTEM

(71) Applicant: Universal Trim Supply Co., Ltd., New Taipei City (TW)

(72) Inventors: Aly Khalifa, Raleigh, NC (US); Shih-Sheng Yang, Taipei City (TW); Chih-Wei Yang, Taipei City (TW); Chih-Hung Chen, New Taipei City (TW)

(73) Assignee: Universal Trim Supply Co., Ltd., New Taipei City (TW)

(21) Appl. No.: 19/180,077

(22) Filed: Apr. 15, 2025

Related U.S. Application Data
(60) Provisional application No. 63/644,319, filed on May 8, 2024.

(51) Int. Cl. B65D 51/16; G01L 9/00

(52) U.S. Cl. CPC B65D 51/1644; G01L 9/0022

(57) ABSTRACT

A pressure signaling system is provided and includes a container and a signaling device disposed on the container. The signaling device is configured to provide a first demonstrable feedback when an internal pressure of the container is greater than or less than an environmental pressure, and the signaling device is further configured to provide a second demonstrable feedback when a difference between the internal pressure of the container and the environmental pressure is reduced.

### CROSS REFERENCE TO RELATED APPLICATIONS

This application claims the benefit of U.S. Provisional Application No. 63/644,319, filed on May 8, 2024. The content of the application is incorporated herein by reference.

### BACKGROUND OF THE INVENTION

### 1. FIELD OF THE INVENTION

The present invention relates to a pressure system, and more specifically, to a pressure signaling system for both positive and negative pressure applications.

### 2. DESCRIPTION OF THE PRIOR ART

With advancement of technology and development of economy, there are more and more consumer goods available in the market. For example, a container system can be used in a food storage application or in a garment application because the container system is able to effectively separate an interior of the container system from an external environment. However, in order to meet different demands, an improved container system is required.

### SUMMARY OF THE INVENTION

It is an objective of the present invention to provide a pressure signaling system for both positive and negative pressure applications.

In order to achieve the aforementioned objective, the present invention discloses a pressure signaling system. The pressure signaling system includes a container and a signaling device disposed on the container and configured to provide a first demonstrable feedback when an internal pressure of the container is greater than or less than an environmental pressure, and the signaling device is further configured to provide a second demonstrable feedback when a difference between the internal pressure of the container and the environmental pressure is reduced.

According to an embodiment of the present invention, the signaling device includes a resilient feature or a moving feature, and the first demonstrable feedback is a change in shape of the signaling device, deriving from deformation of the resilient feature or displacement of the moving feature.

According to an embodiment of the present invention, the signaling device includes a mechanical sound generator, and the second demonstrable feedback is a controlled sound generated by the mechanical sound generator.

According to an embodiment of the present invention, a frequency of the controlled sound is in a range of 1,000 to 10,000 Hz.

According to an embodiment of the present invention, the frequency of the controlled sound is in a range of 2,000 to 4, 000 Hz.

According to an embodiment of the present invention, a sound pressure level of the controlled sound is in a range of 10 to 60 dB in 1 meter away from the mechanical sound generator.

According to an embodiment of the present invention, the signaling device includes a light emitting element, and the first demonstrable feedback or the second demonstrable feedback is a blinking light emitted from the light emitting element.

According to an embodiment of the present invention, the signaling device includes a digital sound generator, and the second demonstrable feedback is a digital sound generated by the digital sound generator.

According to an embodiment of the present invention, the signaling device includes a signal transmission element, and the first demonstrable feedback or the second demonstrable feedback is a signal transmitted from the signal transmission element to a mobile device to actuate the mobile device to generate an audio or visual output corresponding to the signal.

According to an embodiment of the present invention, the signaling device includes a signal transmission element configured to provide an identification information to a mobile device to actuate the mobile device to generate an audio or visual output corresponding to the identification information.

According to an embodiment of the present invention, wherein the signaling device is configured to be powered by inductive energy captured by the mobile device.

According to an embodiment of the present invention, the signaling device is configured to communicate with the mobile device by radio-frequency identification technology.

According to an embodiment of the present invention, the container is a soft bag or a hard box.

In order to achieve the aforementioned objective, the present invention further discloses a pressure signaling system. The pressure signaling system includes a container and a signaling device. The container includes a container portion and a lid portion. The signaling device includes a sensing element configured to sense an internal condition of the container.

According to an embodiment of the present invention, the signaling device further includes a signal transmission element configured to provide a signal to a mobile device according to a sensing result of the sensing element via a wire connection or a wireless connection, so as to actuate the mobile device to generate an audio or visual output corresponding to the signal.

According to an embodiment of the present invention, the signaling device further includes a resilient feature, and the sensing element is configured to sense deformation of the resilient feature, deriving from a change of an internal pressure of the container.

According to an embodiment of the present invention, the sensing element is a piezoelectric element.

According to an embodiment of the present invention, the sensing element includes an exposed electrical contact configured to electrically connect to a measuring device.

According to an embodiment of the present invention, the signaling device further includes a magnet to align a measuring device with the sensing element.

According to an embodiment of the present invention, the signaling device is configured to communicate with a measuring device via a wired connection or a wireless connection.

In summary, the pressure signaling system of the present invention facilitates the user to realize a current internal condition of the container.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a pressure signaling system according to a first embodiment of the present invention.

FIG. 2 is a partial exploded diagram of the pressure signaling system according to the first embodiment of the present invention.

FIG. 3 and FIG. 4 are partial enlarged diagrams of the pressure signaling system in different according to the first embodiment of the present invention.

FIG. 5 and FIG. 6 are partial sectional diagrams of the pressure signaling system in different states according to the first embodiment of the present invention.

FIG. 7 is a partial exploded diagram of a pressure signaling system according to a second embodiment of the present invention.

FIG. 8 and FIG. 9 are partial enlarged diagrams of the pressure signaling system in different states according to the second embodiment of the present invention.

FIG. 10 and FIG. 11 are partial sectional diagrams of the pressure signaling system in different states according to the second embodiment of the present invention.

FIG. 12 is a partial exploded diagram of a pressure signaling system according to a third embodiment of the present invention.

FIG. 13 is a diagram of a digital sound generator according to the third embodiment of the present invention.

FIG. 14 and FIG. 15 are partial enlarged diagrams of the pressure signaling system in different states according to the third embodiment of the present invention.

FIG. 16 and FIG. 17 are partial sectional diagrams of the pressure signaling system in different states according to the third embodiment of the present invention.

FIG. 18 is a partial exploded diagram of a pressure signaling system according to a fourth embodiment of the present invention.

FIG. 19 is a diagram of a light generator according to the fourth embodiment of the present invention.

FIG. 20 and FIG. 21 are partial enlarged diagrams of the pressure signaling system in different states according to the fourth embodiment of the present invention.

FIG. 22 and FIG. 23 are partial sectional diagrams of the pressure signaling system in different states according to the fourth embodiment of the present invention.

FIG. 24 is a partial diagram of a pressure signaling system according to a fifth embodiment of the present invention.

FIG. 25 is an exploded diagram of a signaling device according to the fifth embodiment of the present invention.

FIG. 26 and FIG. 27 are diagrams of the pressure signaling system in different states according to the fifth embodiment of the present invention.

FIG. 28 is a schematic diagram of a pressure signaling system according to a sixth embodiment of the present invention.

FIG. 29 and FIG. 30 are sectional diagrams of the pressure signaling system according to the sixth embodiment of the present invention.

FIG. 31 is a schematic diagram of a pressure signaling system according to a seventh embodiment of the present invention.

FIG. 32 is a diagram of a signaling device according to the seventh embodiment of the present invention.

FIG. 33 is a sectional diagram of the pressure signaling system according to the seventh embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “connect” is intended to mean either an indirect or direct mechanical/electrical connection. Thus, if a first device is connected to a second device, that connection may be through a direct mechanical/electrical connection, or through an indirect mechanical/electrical connection via other devices and connections.

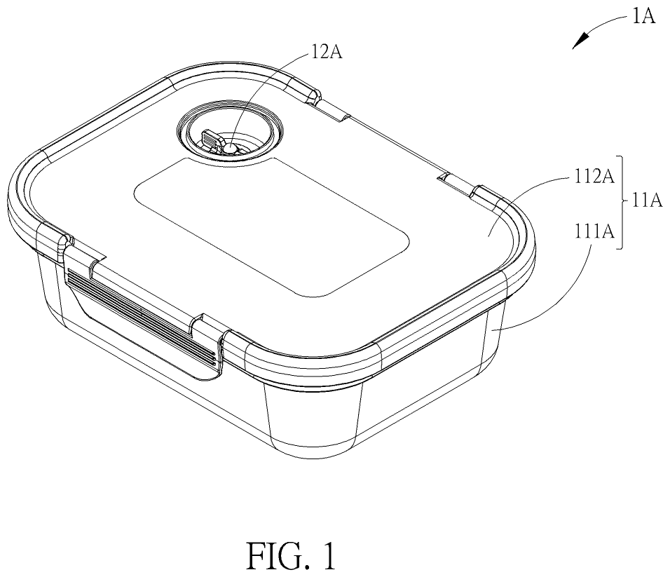

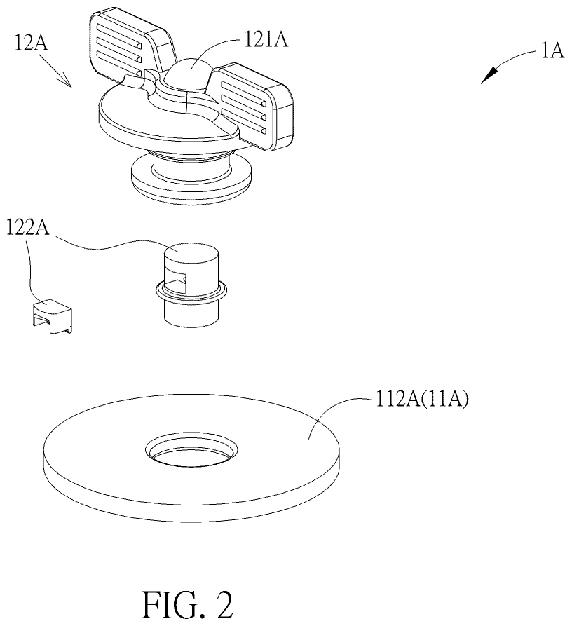

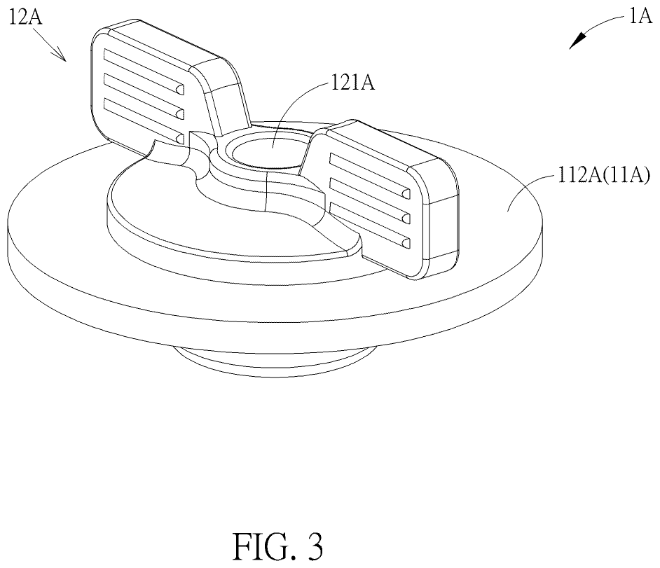

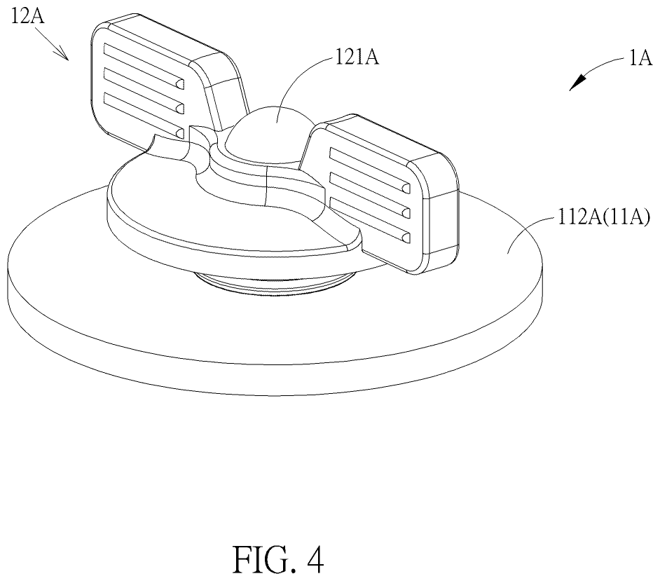

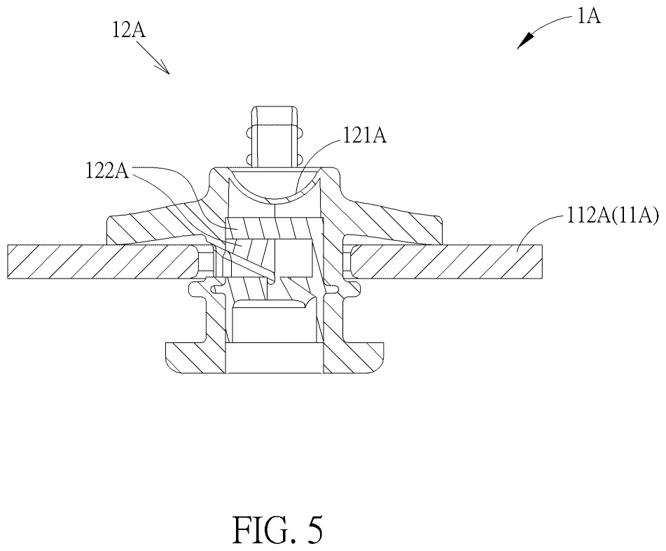

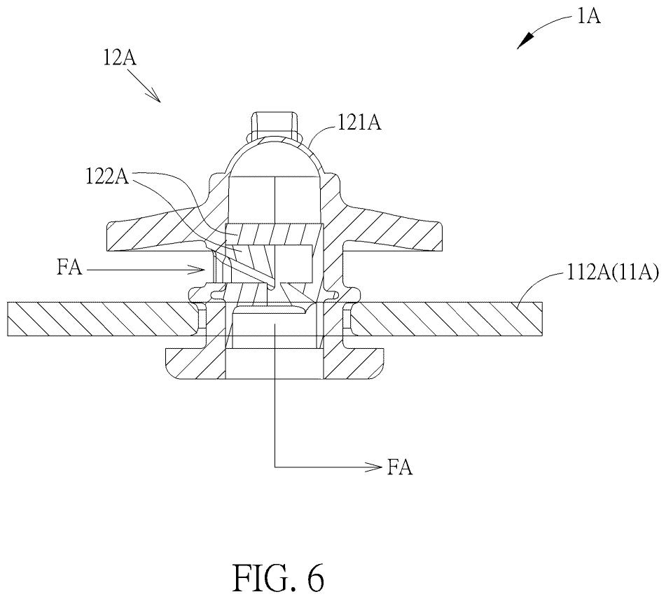

Please refer to FIG. 1 to FIG. 6. FIG. 1 is a schematic diagram of a pressure signaling system 1A according to a first embodiment of the present invention. FIG. 2 is a partial exploded diagram of the pressure signaling system 1A according to the first embodiment of the present invention. FIG. 3 and FIG. 4 are partial enlarged diagrams of the pressure signaling system 1A in different states according to the first embodiment of the present invention. FIG. 5 and FIG. 6 are partial sectional diagrams of the pressure signaling system 1A in different states according to the first embodiment of the present invention. As shown in FIG. 1 to FIG. 6, in the first embodiment, the pressure signaling system 1A includes a container 11A and a signaling device 12A disposed on the container 11A. Specifically, in the first embodiment, the container 11A is a hard box in a negative pressure application and has a container portion 111A and a lid portion 112A, and the signaling device 12A is disposed on the lid portion 112A. Besides, in the first embodiment, the signaling device 12A is configured to provide a first demonstrable feedback when an internal pressure of the container 11A is less than an environmental pressure, and the signaling device 12A is further configured to provide a second demonstrable feedback when a difference between the internal pressure of the container 11A and the environmental pressure is reduced. However, the present invention is not limited to this embodiment. For example, in another embodiment, the container can be a soft bag in a negative pressure application and have two films, and the signaling device is disposed on one of the two films and configured to provide the first demonstrable feedback when the internal pressure of the container is less than the environmental pressure as well as the second demonstrable feedback when the difference between the internal pressure of the container and the environmental pressure is reduced. Alternatively, the container also can be a soft bag in a positive pressure application, and the signaling device is disposed on one of the two films and configured to provide the first demonstrable feedback when the internal pressure of the container is greater than the environmental pressure as well as the second demonstrable feedback when the difference between the internal pressure of the container and the environmental pressure is reduced.

Furthermore, in the first embodiment, the signaling device 12A is in a form of a one-way valve which can move between a pressure maintaining state as shown in FIG. 3 and FIG. 5 and a pressure releasing state as shown in FIG. 4 and FIG. 6, switching between different height levels relative to the container 11A. The signaling device 12A includes a demonstrable portion 121A with a resilient feature or a moving feature, and the first demonstrable feedback is a change in shape or position of the demonstrable portion 121A, deriving from deformation of the resilient feature or displacement of the moving feature caused by the difference between the internal pressure of the container 11A and the environmental pressure, for example, when the signaling device 12A is in the pressure maintaining state as shown in FIG. 3 and FIG. 5. Specifically, for example, the resilient feature can be a resilient bubble, which can be resiliently collapsed and recover according the difference between the internal pressure of the container 11A and the environmental pressure, and the moving feature can be a spring-biased moving button, which can move between different positions according the difference between the internal pressure of the container 11A and the environmental pressure.

Besides, in the first embodiment, the signaling device 12A further includes a mechanical sound generator 122A, such as a whistle, and the second demonstrable feedback is a controlled sound generated by the mechanical sound generator 122A, for example, when the signaling device 12A is in the pressure releasing state as shown in FIG. 4 and FIG. 6, allowing an air flow FA flowing from an external environment to an interior of the container 11A through the mechanical sound generator 122A for reducing the difference between the internal pressure of the container 11A and the environmental pressure, i.e., balancing the internal pressure of the container 11A and the environmental pressure.

In the first embodiment, it is easy for a user to be aware of whether the internal pressure of the container 11A is less than the environmental pressure by observing the shape of the demonstrable portion 121A, and to be aware of whether the difference between the internal pressure of the container 11A and the environmental pressure is reduced by hearing the controlled sound generated by the mechanical sound generator 122A.

Preferably, a frequency of the controlled sound is in a range of 1,000 to 10,000 Hz. More preferably, the frequency of the controlled sound is in a range of 2,000 to 4,000 Hz.

Preferably, a sound pressure level of the controlled sound is in a range of 10 to 60 dB in 1 meter away from the mechanical sound generator.

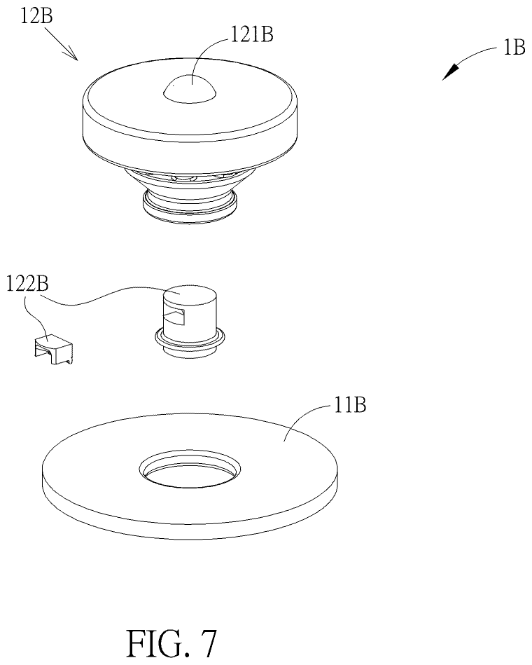

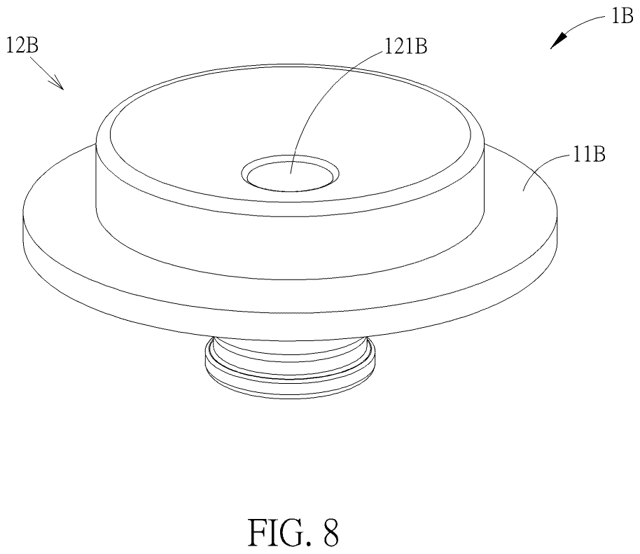

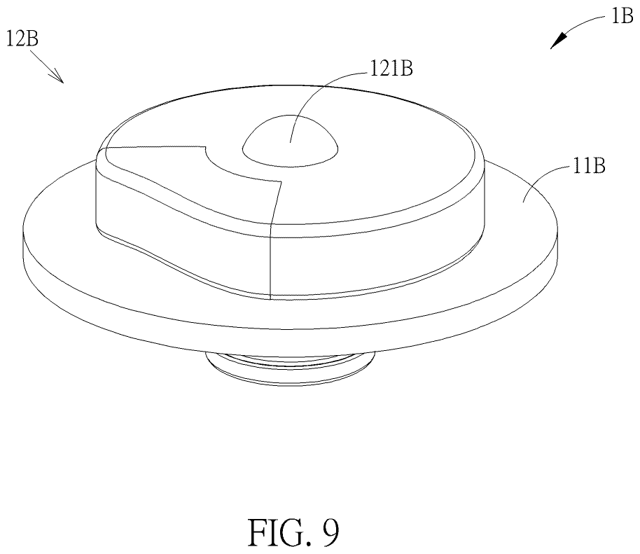

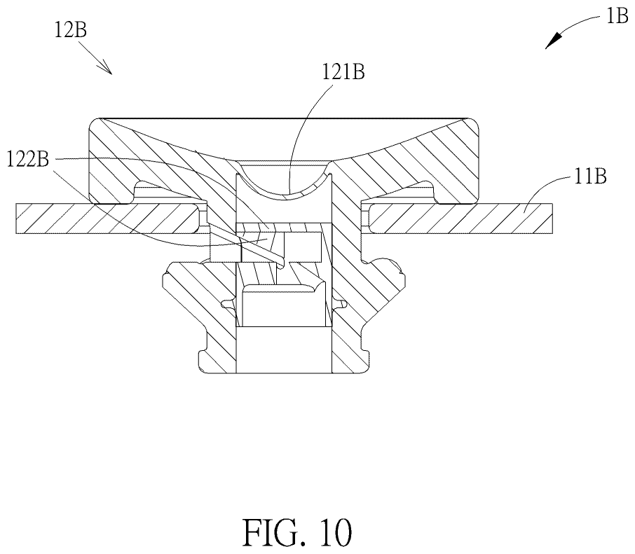

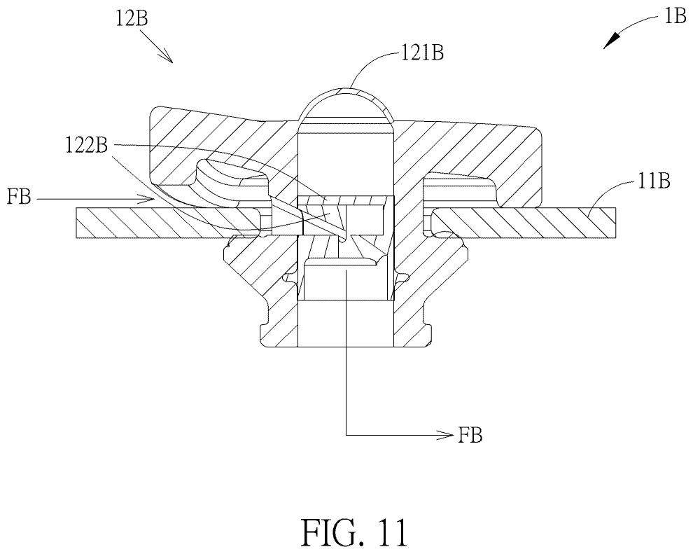

Please refer to FIG. 7 to FIG. 11. FIG. 7 is a partial exploded diagram of a pressure signaling system 1B according to a second embodiment of the present invention. FIG. 8 and FIG. 9 are partial enlarged diagrams of the pressure signaling system 1B in different states according to the second embodiment of the present invention. FIG. 10 and FIG. 11 are partial sectional diagrams of the pressure signaling system 1B in different states according to the second embodiment of the present invention. As shown in FIG. 7 to FIG. 11, in the second embodiment, different from the first embodiment, a signaling device 12B of the pressure signaling system 1B is in a form of a one-way valve, which can move between a pressure maintaining state as shown in FIG. 8 and FIG. 10 and a pressure releasing state as shown in FIG. 9 and FIG. 11, staying at a same height level relative to a container 11B. Furthermore, in the second embodiment, similar to the first embodiment, the signaling device 12B includes a demonstrable portion 121B with a resilient feature or a moving feature, and a mechanical sound generator 122B, such as a whistle. A first demonstrable feedback is a change in shape or position of the demonstrable portion 121B, deriving from deformation of the resilient feature or displacement of the moving feature caused by a difference between an internal pressure of the container 11B and an environmental pressure, for example, when the signaling device 12B is in the pressure maintaining state as shown in FIG. 8 and FIG. 10, and a second demonstrable feedback is a controlled sound generated by the mechanical sound generator 122B, for example, when the signaling device 12B is in the pressure releasing state as shown in FIG. 9 and FIG. 11, allowing an air flow FB flowing from an external environment to an interior of the container 11B through the mechanical sound generator 122B for reducing the difference between the internal pressure of the container 11B and the environmental pressure, i.e., balancing the internal pressure of the container 11B and the environmental pressure.

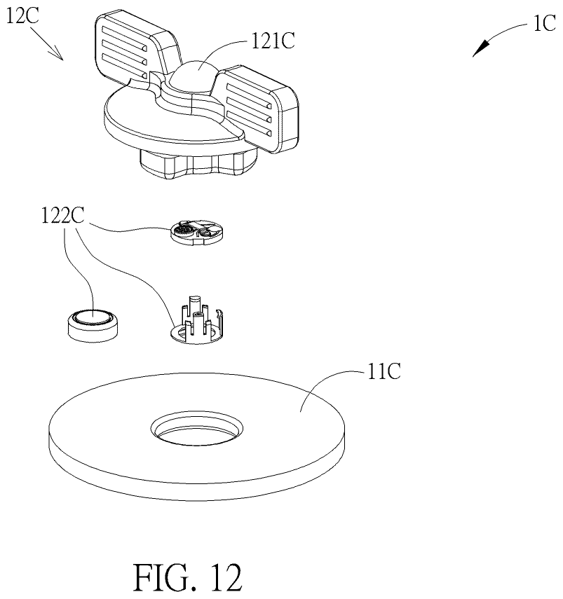

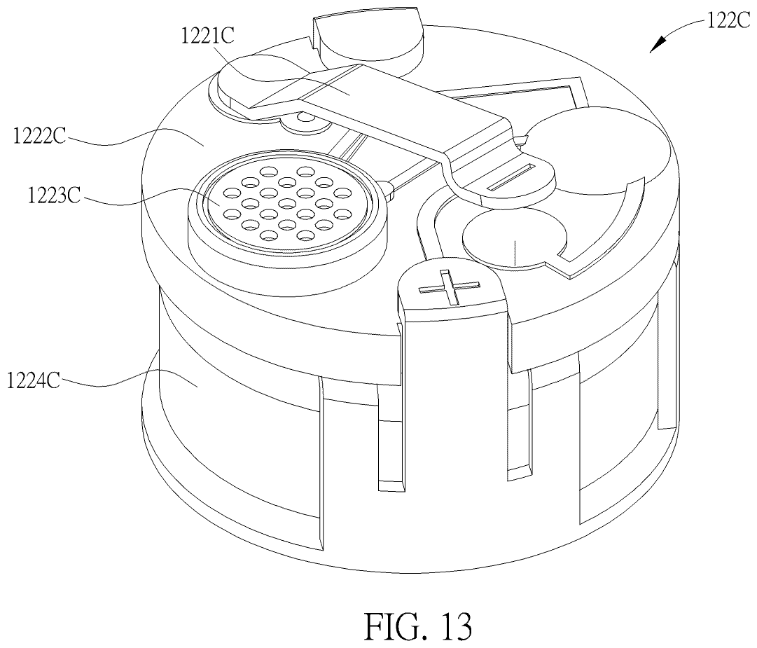

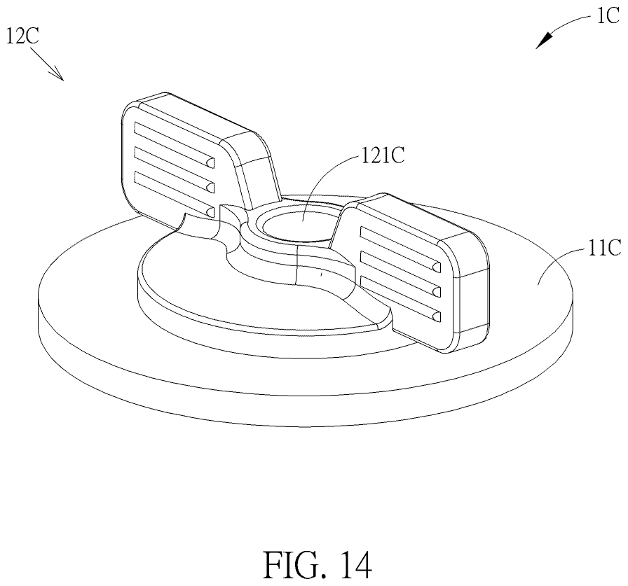

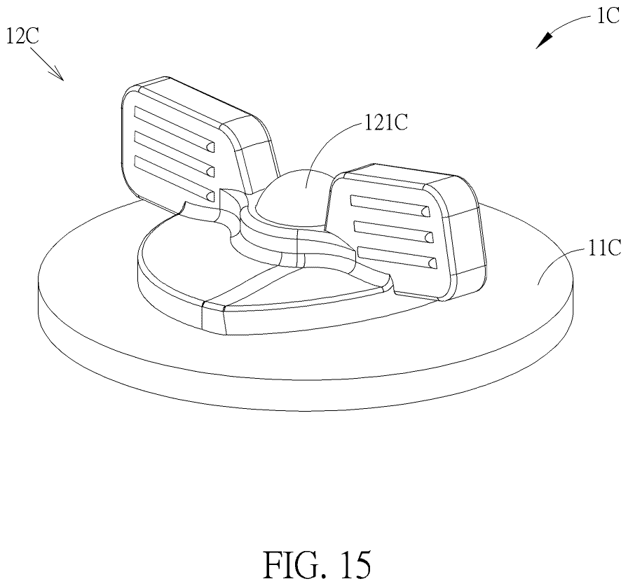

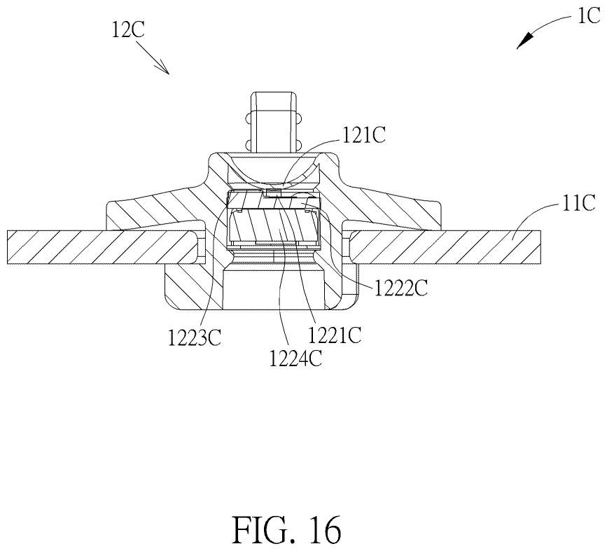

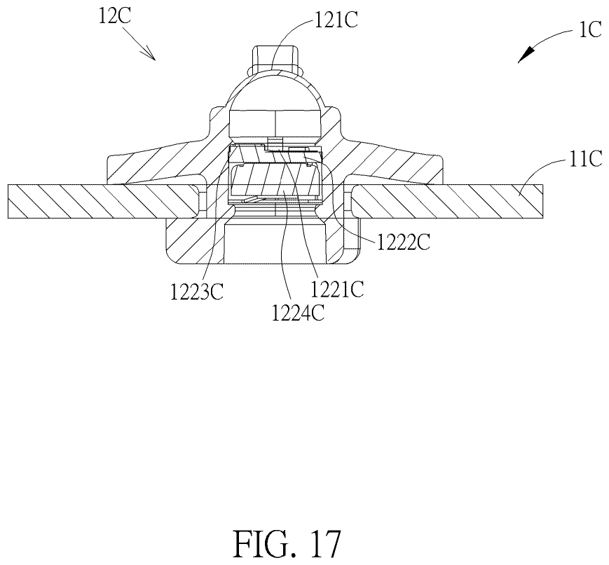

Please refer to FIG. 12 to FIG. 17. FIG. 12 is a partial exploded diagram of a pressure signaling system 1C according to a third embodiment of the present invention. FIG. 13 is a diagram of a digital sound generator 122C according to the third embodiment of the present invention. FIG. 14 and FIG. 15 are partial enlarged diagrams of the pressure signaling system 1C in different states according to the third embodiment of the present invention. FIG. 16 and FIG. 17 are partial sectional diagrams of the pressure signaling system 1C in different states 1C according to the third embodiment of the present invention. As shown in FIG. 12 to FIG. 17, in the third embodiment, different from the first embodiment, a signaling device 12C of the pressure signaling system 1C is in a form of a one-way valve, which can move between a pressure maintaining state as shown in FIG. 14 and FIG. 16 and a pressure releasing state as shown in FIG. 15 and FIG. 17, staying at a same height level relative to a container 11C. Besides, in the third embodiment, different from the first embodiment, the signaling device 12C includes a demonstrable portion 121C with a resilient feature or a moving feature, and the digital sound generator 122C. For example, the digital sound generator 122C can include a switch 1221C, a circuit board 1222C, a speaker 1223C and a battery 1224C. A first demonstrable feedback is a change in shape or position of the demonstrable portion 121C, deriving from deformation of the resilient feature or displacement of the moving feature caused by a difference between an internal pressure of the container 11C and an environmental pressure, for example, when the signaling device 12C is in the pressure maintaining state as shown in FIG. 14 and FIG. 16 where the switch 1221C is pressed by the demonstrable portion 121C. A second demonstrable feedback is a digital sound generated by the digital sound generator 122C, for example, when the signaling device 12C is in the pressure releasing state as shown in FIG. 15 and FIG. 17 where the switch 1221C is not pressed by the demonstrable portion 121C.

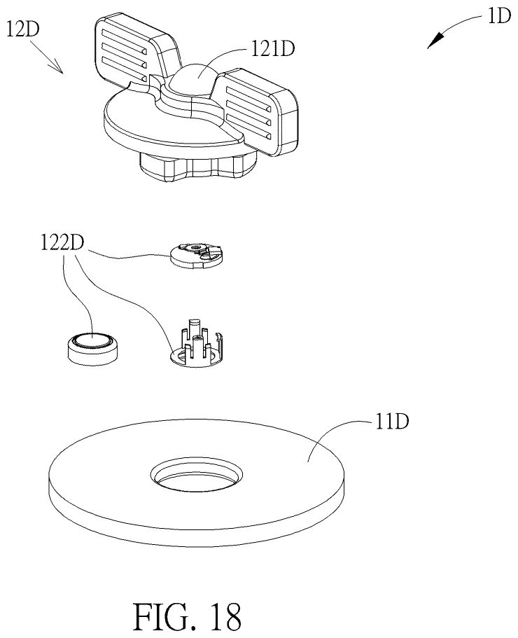

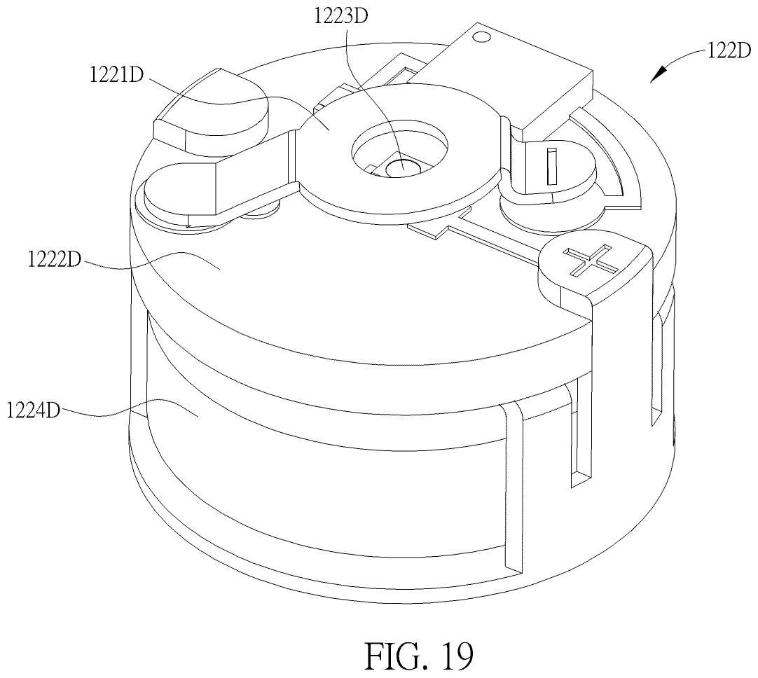

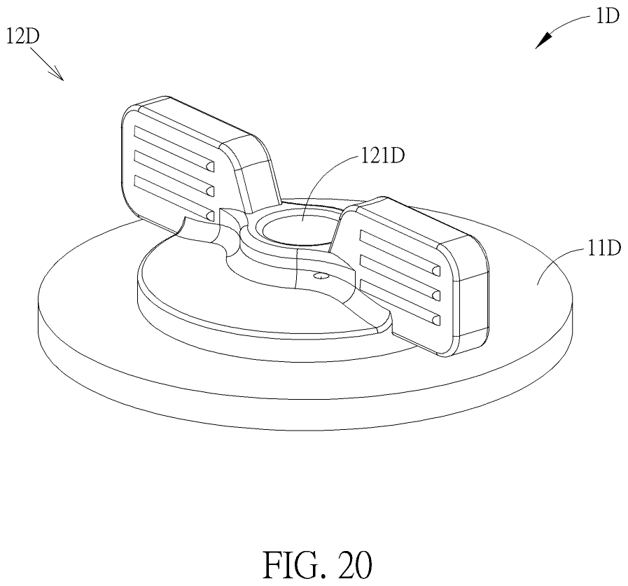

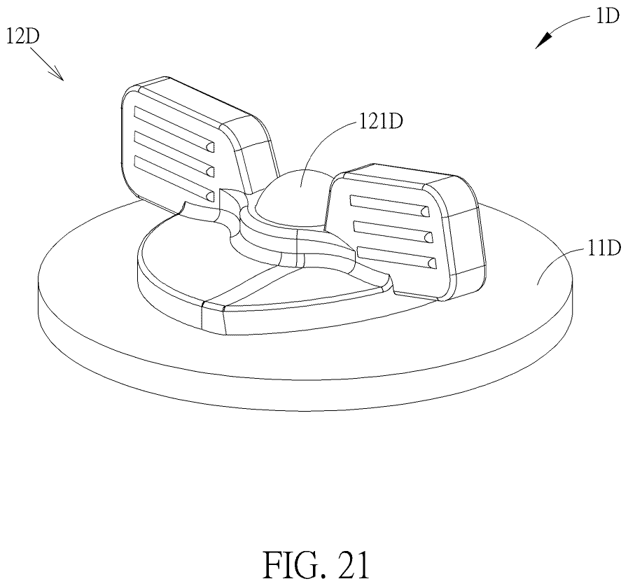

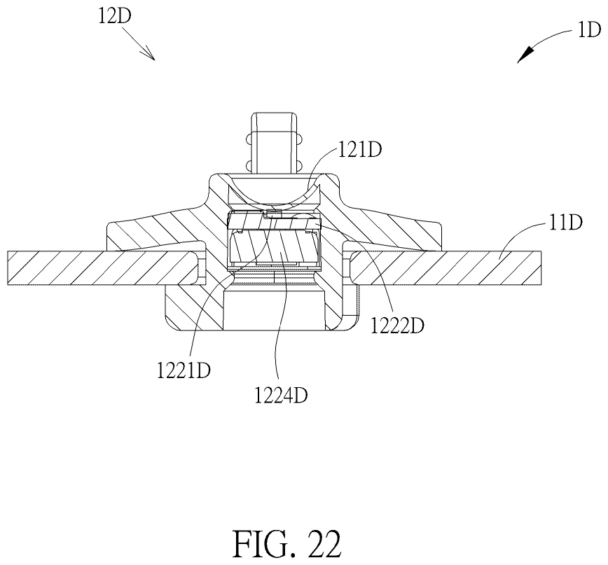

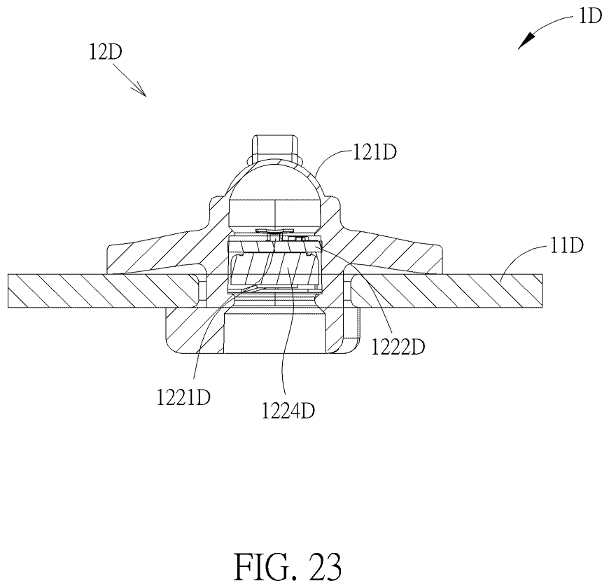

Please refer to FIG. 18 to FIG. 23. FIG. 18 is a partial exploded diagram of a pressure signaling system 1D according to a fourth embodiment of the present invention. FIG. 19 is a diagram of a light generator 122D according to the fourth embodiment of the present invention. FIG. 20 and FIG. 21 are partial enlarged diagrams of the pressure signaling system 1D in different states according to the fourth embodiment of the present invention. FIG. 22 and FIG. 23 are partial sectional diagrams of the pressure signaling system 1D in different states according to the fourth embodiment of the present invention. As shown in FIG. 18 to FIG. 23, in the fourth embodiment, different from the first embodiment, a signaling device 12D of the pressure signaling system 1D is in a form of a one-way valve, which can move between a pressure maintaining state as shown in FIG. 20 and FIG. 22 and a pressure releasing state as shown in FIG. 21 and FIG. 23, staying at a same height level relative to a container 11D. Besides, in the fourth embodiment, different from the first embodiment, the signaling device 12D includes a demonstrable portion 121D with a resilient feature or a moving feature, and a light generator 122D. For example, the light generator 122D can include a switch 1221D, a circuit board 1222D, a light emitting element 1223D, such as a light emitting diode, and a battery 1224D. A first demonstrable feedback is a change in shape or position of the demonstrable portion 121D, deriving from deformation of the resilient feature or displacement of the moving feature caused by a difference between an internal pressure of the container 11D and an environmental pressure, for example, when the signaling device 12D is in the pressure maintaining state as shown in FIG. 20 and FIG. 21 where the switch 1221D is pressed by the demonstrable portion 121D. A second demonstrable feedback is a blinking light emitted from the light emitting element 1223D, for example, when the signaling device 12D is in the pressure releasing state as shown in FIG. 22 and FIG. 23 where the switch 1221D is not pressed by the demonstrable portion 121D.

However, the present invention is not limited to this embodiment. For example, in another embodiment, the first demonstrable feedback can be a change in shape or position of the signaling device, deriving from deformation of the resilient feature or displacement of the moving feature accompanied with a first blinking light, and the second demonstrable feedback can be a second blinking light, wherein the first blinking light and the second blinking light can have different blinking frequencies and/or different colors.

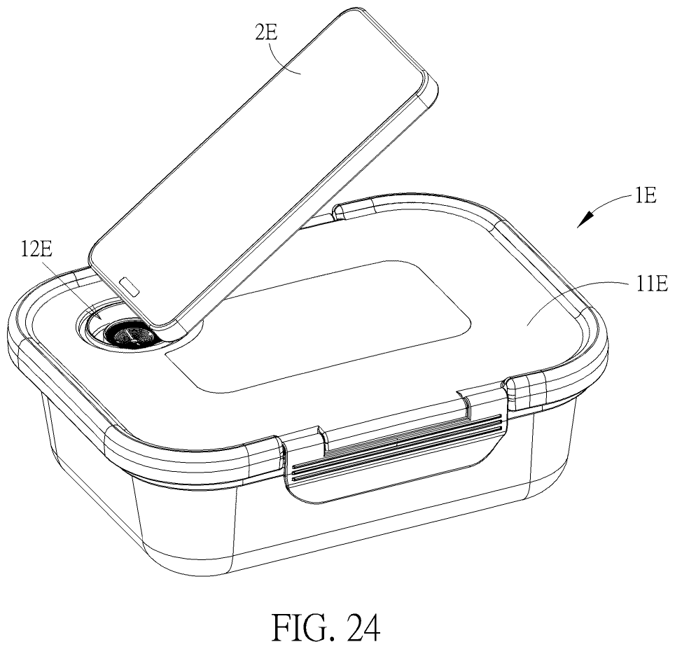

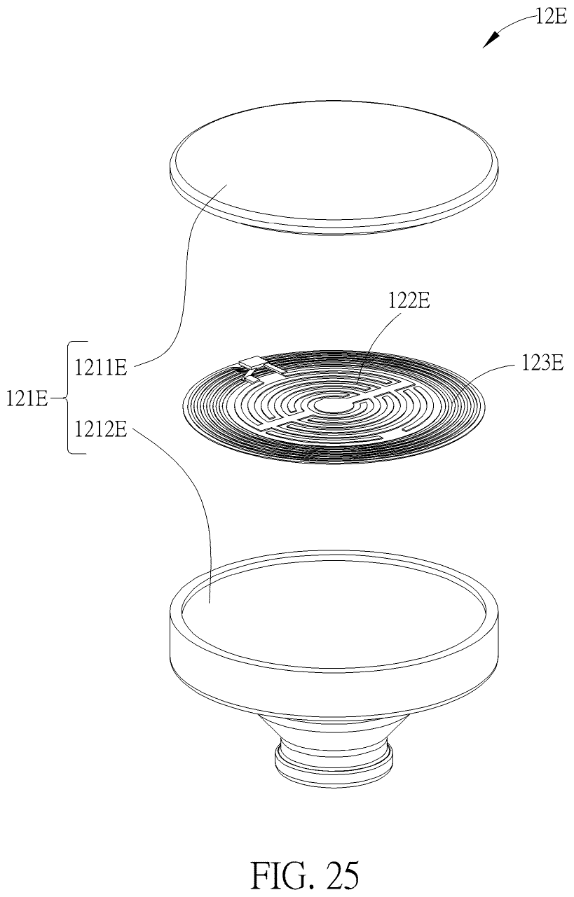

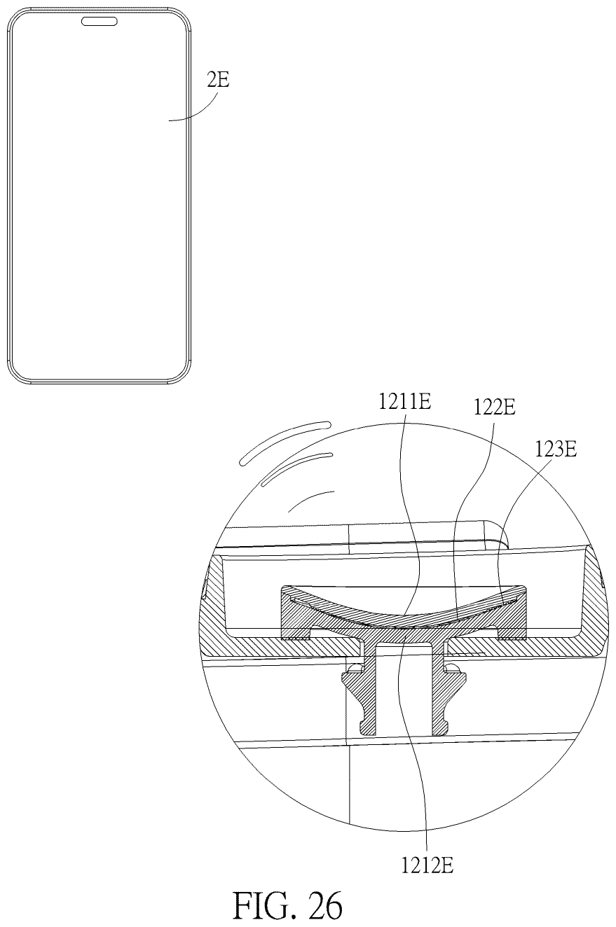

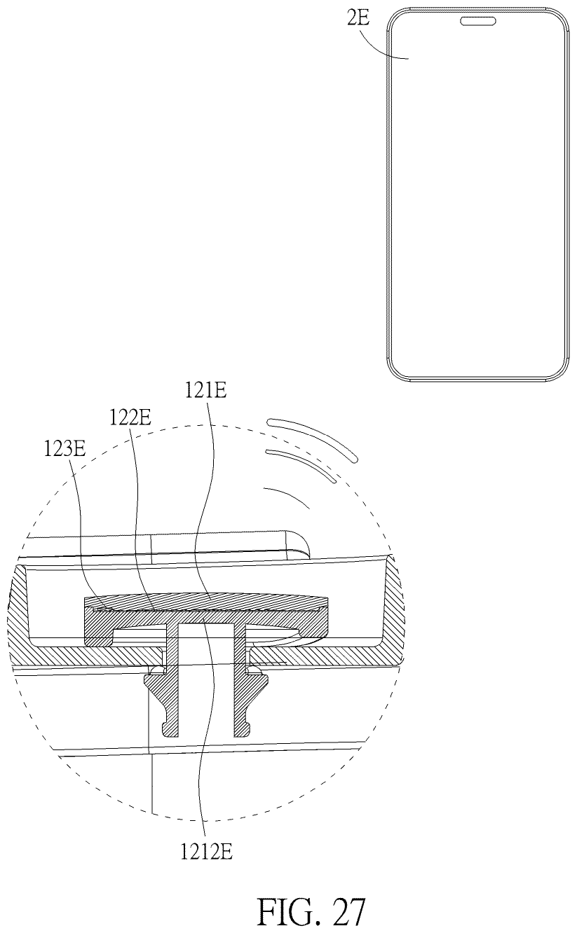

Please refer to FIG. 24 to FIG. 27. FIG. 24 is a partial diagram of a pressure signaling system 1E according to a fifth embodiment of the present invention. FIG. 25 is an exploded diagram of a signaling device 12E according to the fifth embodiment of the present invention. FIG. 26 and FIG. 27 are diagrams of the pressure signaling system 1E in different states according to the fifth embodiment of the present invention. As shown in FIG. 24 to FIG. 27, in the fifth embodiment, different from the first embodiment, the signaling device 12E of the pressure signaling system 1E is in a form of a one-way valve, which can move between a pressure maintaining state as shown in FIG. 26 and a pressure releasing state as shown in FIG. 27, staying at a same height level relative to a container 11E. Besides, in the fifth embodiment, different from the first embodiment, the signaling device 12E includes a demonstrable portion 121E with a resilient feature, a sensing element 122E, such as a piezoelectric element, and a signal transmission element 123E, such as a radio frequency identification (RFID) tag configured to be powered by inductive energy captured by a mobile device 2E, such as a mobile phone, to communicate with the mobile device 2E by radio-frequency identification technology. The sensing element 122E is disposed between an upper part 1211E and a lower part 1212E of the demonstrate portion 121E and configured to sense deformation of the resilient feature, deriving from a change of an internal pressure of the container 11E. The signal transmission element 123E is configured to provide a signal to the mobile device 2E according to a sensing result of the sensing element 122E via a wireless RFID connection, so as to actuate the mobile device 2E to generate an audio or visual output corresponding to the signal. Specifically, as the resilient feature deforms, the sensing element 122E can deform to generate a voltage signal reflecting a difference between the internal pressure of the container 11E and an environmental pressure. The signal transmission element 123E can transmit the voltage signal to the mobile device 2E to actuate the mobile device 2E to generate an audio or visual output corresponding to the voltage signal, for example, to provide an audio or visual notification for allowing a user to realize a current pressure condition of the interior of the container 11E. In other words, in the fifth embodiment, the first demonstrable feedback and the second demonstrable feedback are signals transmitted from the signal transmission element to the mobile device 2E to actuate the mobile device 2E to generate different audio or visual outputs corresponding to the signals, respectively. Understandably, in another embodiment, the first demonstrable feedback or the second demonstrable feedback can be a sound generated by a mechanical or digital sound generator or a light generated by a light generator instead of a signal transmitted to the mobile device.

Furthermore, in the fifth embodiment, the signal transmission element 123E is further configured to provide an identification information to the mobile device 2E to actuate the mobile device 2E to generate another audio or visual output corresponding to the identification information, for example, to provide another audio or visual notification for allowing the user to realize an appropriate pressure range suitable for the container 11E.

However, the present invention is not limited to this embodiment. For example, in another embodiment, the signaling device can be powered by a battery, and the signal transmission element of the signaling device can be a Bluetooth element configured to communicate with the mobile device via a wireless connection, or an electrical connector configured to communicate with the mobile device via a wired connection.

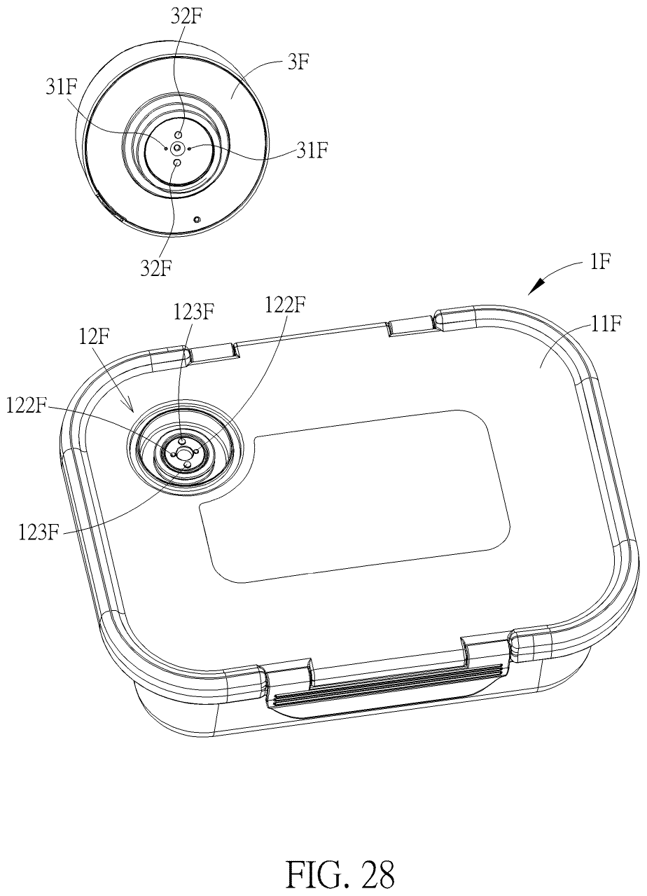

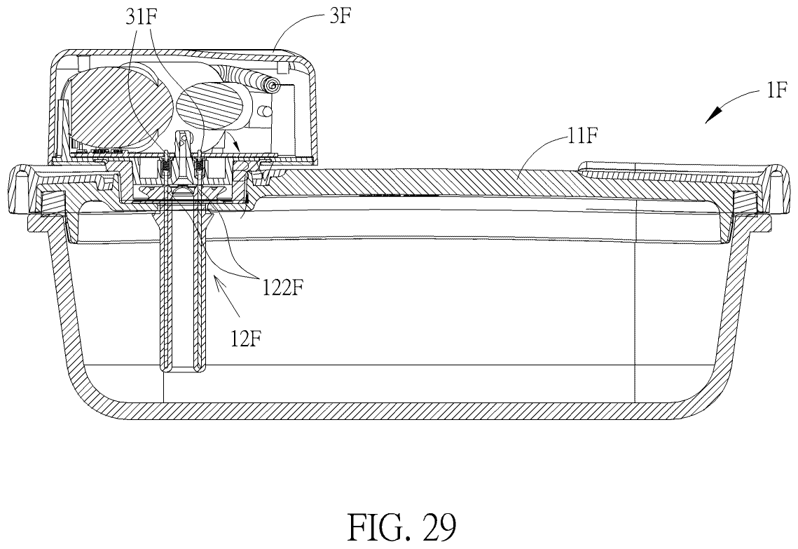

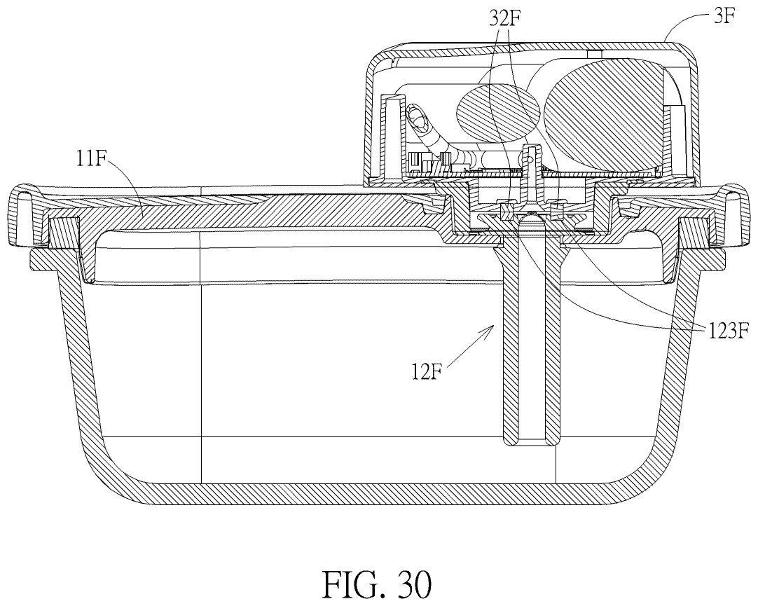

Please refer to FIG. 28 to FIG. 30. FIG. 28 is a schematic diagram of a pressure signaling system 1F according to a sixth embodiment of the present invention. FIG. 29 and FIG. 30 are sectional diagrams of the pressure signaling system 1F according to the sixth embodiment of the present invention. As shown in FIG. 28 to FIG. 30, in the sixth embodiment, different from the first embodiment, a signaling device 12F of the pressure signaling system 1F is in a form of a one-way valve, as shown in FIG. 28 to FIG. 30, and the signaling device 12F includes a demonstrable portion 121F with a resilient feature or a moving feature, at least one sensing element 122F, such as a probe, and at least one magnet 123F. The sensing element 122F is configured to sense an internal condition of a container 11F, such as an internal pressure, an internal temperature, an internal acid content, an internal brine concentration or an internal humidity. The sensing element 122F has an exposed electrical contact configured to electrically connect to a spring-biased pin 31F of a measuring device 3F, such as a portable pump. In other words, in the sixth embodiment, the signaling device 12F is configured to communicate with the measuring device 3F via a wired connection through the exposed electrical contact of the sensing element 122F. The magnet 123F is configured to magnetically attract a corresponding magnet 32F of the measuring device 3F to align the spring-biased pin 31F of the measuring device 3F with the exposed electrical contact of the sensing element 122F for facilitating an electrical connection between the spring-biased pin 31F of the measuring device 3F and the exposed electrical contact of the sensing element 122F.

Understandably, in another embodiment, the signaling device can further include the mechanical sound generator of the second embodiment, the digital sound generator of the third embodiment or the light generator of the fourth embodiment in addition to the demonstrable portion, the at least one sensing element and the at least one magnet of the sixth embodiment.

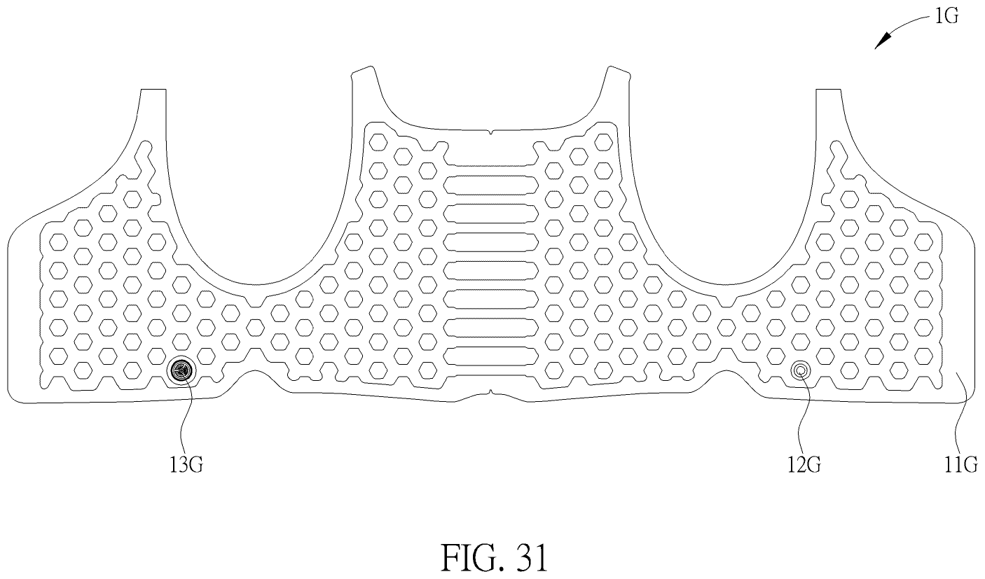

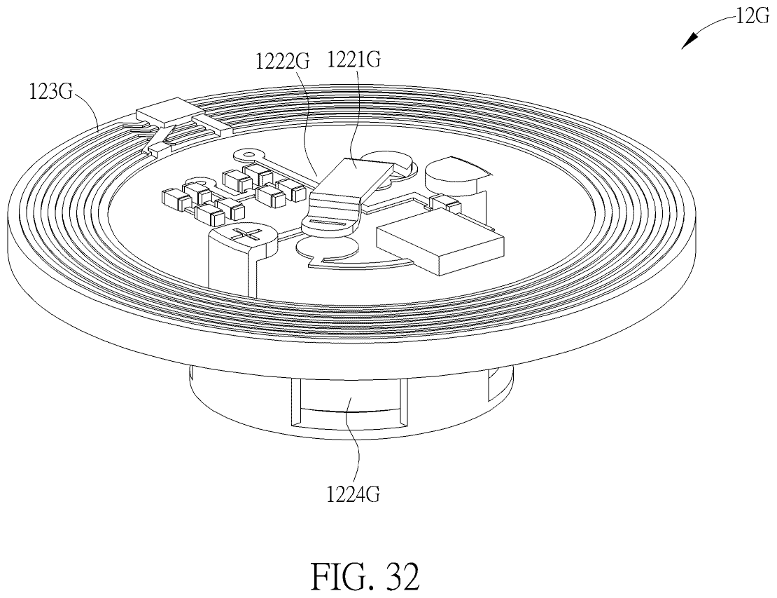

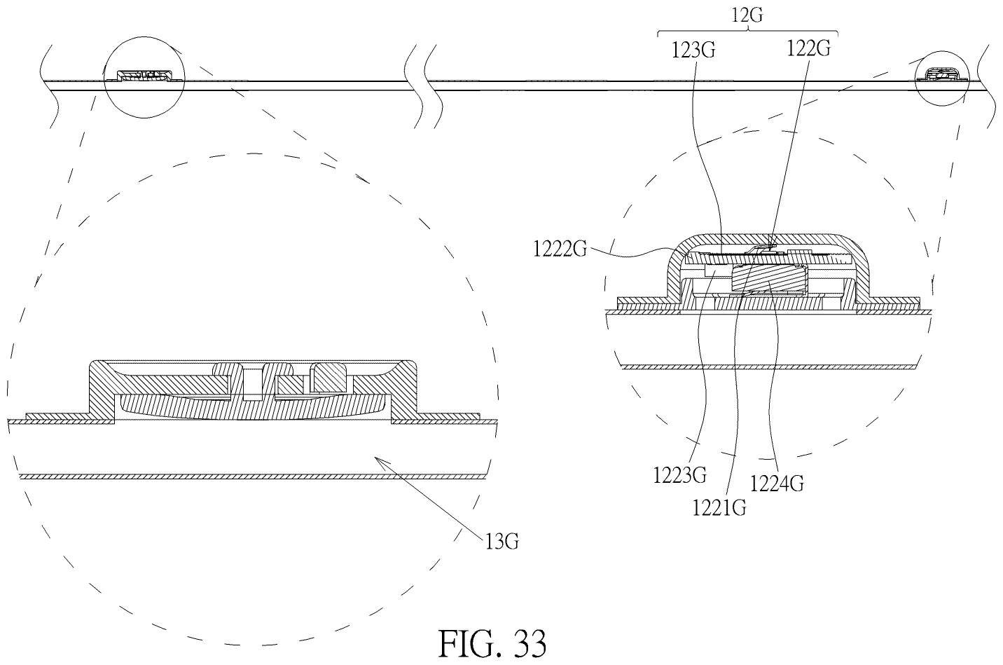

Please refer to FIG. 31 to FIG. 33. FIG. 31 is a schematic diagram of a pressure signaling system 1G according to a seventh embodiment of the present invention. FIG. 32 is a diagram of a signaling device 12G according to the seventh embodiment of the present invention. FIG. 33 is a sectional diagram of the pressure signaling system 1G according to the seventh embodiment of the present invention. As shown in FIG. 31 to FIG. 33, in the seventh embodiment, a container 11G of the pressure signaling system 1G is a soft bag for a garment in a positive pressure application and having two films, and the signaling device 12G of the pressure signaling system 1G is disposed on one of the two films and in a form of an independent device from a one-way valve 13G. Understandably, in another embodiment, the signaling device and the one-way valve can be integrally formed with each other. The signaling device 12G includes a sensing element 122G and a signal transmission element 123G. For example, the sensing element 122G can include a switch 1221G, a circuit board 1222G, a sensor 1223, such as a temperature sensor or a pressure sensor, and a battery 1224G, and the signal transmission element 123G can be a RFID tag attached on the circuit board 1222G. When the switch 1221G is pressed by a user, the battery 1224G is configured to provide electricity to the sensor 1223G to actuate the sensor 1223G to sense an internal condition of a container 11G, such as an internal temperature or an internal pressure. Understandably, in another embodiment, the switch and the battery can be omitted, and the sensor can be powered by inductive energy captured from a mobile device instead of a battery. The signal transmission element 123G is configured to provide a signal to a mobile device according to a sensing result of the sensing element 122G and/or an identification information via a wireless RFID connection, so as to actuate the mobile device to generate an audio or visual output corresponding to the signal, for example, to provide an audio or visual notification for allowing a user to realize a current temperature or pressure condition of the interior of the container 11E, and/or an audio or visual output corresponding to the identification information, for example, to provide an audio or visual notification for allowing the user to realize an appropriate temperature or pressure range suitable for the container 11G.

In contrast to the prior art, the pressure signaling system of the present invention facilitates the user to realize a current internal condition of the container.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pressure signaling system comprising:
a container; and
a signaling device disposed on the container and configured to provide a first demonstrable feedback when an internal pressure of the container is greater than or less than an environmental pressure, and the signaling device being further configured to provide a second demonstrable feedback when a difference between the internal pressure of the container and the environmental pressure is reduced.

2. The pressure signaling system of claim 1, wherein the signaling device comprises a demonstrable portion with a resilient feature or a moving feature, and the first demonstrable feedback is a change in shape or position of the demonstrable portion, deriving from deformation of the resilient feature or displacement of the moving feature.

3. The pressure signaling system of claim 1, wherein the signaling device comprises a mechanical sound generator, and the second demonstrable feedback is a controlled sound generated by the mechanical sound generator.

4. The pressure signaling system of claim 3, wherein a frequency of the controlled sound is in a range of 1, 000 to 10, 000 Hz.

5. The pressure signaling system of claim 4, wherein the frequency of the controlled sound is in a range of 2,000 to 4,000 Hz.

6. The pressure signaling system of claim 3, wherein a sound pressure level of the controlled sound is in a range of 10 to 60 dB in 1 meter away from the mechanical sound generator.

7. The pressure signaling system of claim 1, wherein the signaling device comprises a light emitting element, and the first demonstrable feedback or the second demonstrable feedback is a blinking light emitted from the light emitting element.

8. The pressure signaling system of claim 1, wherein the signaling device comprises a digital sound generator, and the second demonstrable feedback is a digital sound generated by the digital sound generator.

9. The pressure signaling system of claim 1, wherein the signaling device comprises a signal transmission element, and the first demonstrable feedback or the second demonstrable feedback is a signal transmitted from the signal transmission element to a mobile device to actuate the mobile device to generate an audio or visual output corresponding to the signal.

10. The pressure signaling system of claim 1, wherein the signaling device comprises a signal transmission element configured to provide an identification information to a mobile device to actuate the mobile device to generate an audio or visual output corresponding to the identification information.

11. The pressure signaling system of claim 10, wherein the signaling device is configured to be powered by inductive energy captured by the mobile device.

12. The pressure signaling system of claim 11, wherein the signaling device is configured to communicate with the mobile device by radio-frequency identification technology.

13. The pressure signaling system of claim 1, wherein the container is a soft bag or a hard box.

14. A pressure signaling system comprising:
a container comprising:
a container portion; and
a lid portion; and
a signaling device comprising a sensing element configured to sense an internal condition of the container.

15. The pressure signaling system of claim 14, wherein the signaling device further comprises a signal transmission element configured to provide a signal to a mobile device according to a sensing result of the sensing element via a wire connection or a wireless connection, so as to actuate the mobile device to generate an audio or visual output corresponding to the signal.

16. The pressure signaling system of claim 14, wherein the signaling device further comprises a resilient feature, and the sensing element is configured to sense deformation of the resilient feature, deriving from a change of an internal pressure of the container.

17. The pressure signaling system of claim 16, wherein the sensing element is a piezoelectric element.

18. The pressure signaling system of claim 14, wherein the sensing element comprises an exposed electrical contact configured to electrically connect to a measuring device.

19. The pressure signaling system of claim 14, wherein the signaling device further comprises a magnet to align a measuring device with the sensing element.

20. The pressure signaling system of claim 14, wherein the signaling device is configured to communicate with a measuring device via a wired connection or a wireless connection.
